(19) United States
(12) Patent Application Publication
(10) Pub. No.: US 2016/0101854 A1
(43) Pub. Date: Apr. 14, 2016

(54) Gyroplane

(71) Applicant: Dingwen Du, Changsha (CN)

(72) Inventor: Dingwen Du, Changsha (CN)

(21) Appl. No.: 14/970,543

(22) Filed: Dec. 16, 2015

Related U.S. Application Data
(63) Continuation-in-part of application No. PCT/CN2013/080164, filed on Jul. 26, 2013.

(51) Int. Cl. B64C 29/00

(52) U.S. Cl. CPC B64C 29/0033

(57) ABSTRACT

The present invention relates to a gyroplane comprising rotating wings with hydraulically-operated fan propellers. The rotating wing (6) with hydraulically-operated fan propellers comprises a radial hydraulic motor (6-2) and hydraulically-operated fan propellers (6-1). A wing rotating intermediate spar supported on a bearing (6-5) in a bearing support fixedly connected to a rotating wing fuselage (6-4) is fixedly connected with a wing rotating cantilever spar (6-3). A left wing rotating cantilever spar on the left side of the rotating wing fuselage and a right wing rotating cantilever spar on the right side of the rotating wing fuselage are fixedly connected to the wing rotating intermediate spar and distributed in bilateral symmetry. The wing rotating cantilever spar (6-3) is fixedly connected with the front end and the back end of a motor front connecting plate (6-2.2) and a motor back connecting plate (6-2.14) of a hydraulically-operated fan propeller motor (6-2), and frameworks on rotating wings (6-7) are fixedly connected with the wing rotating cantilever spar. The present invention provides a safe and effective air vehicle with low cost.

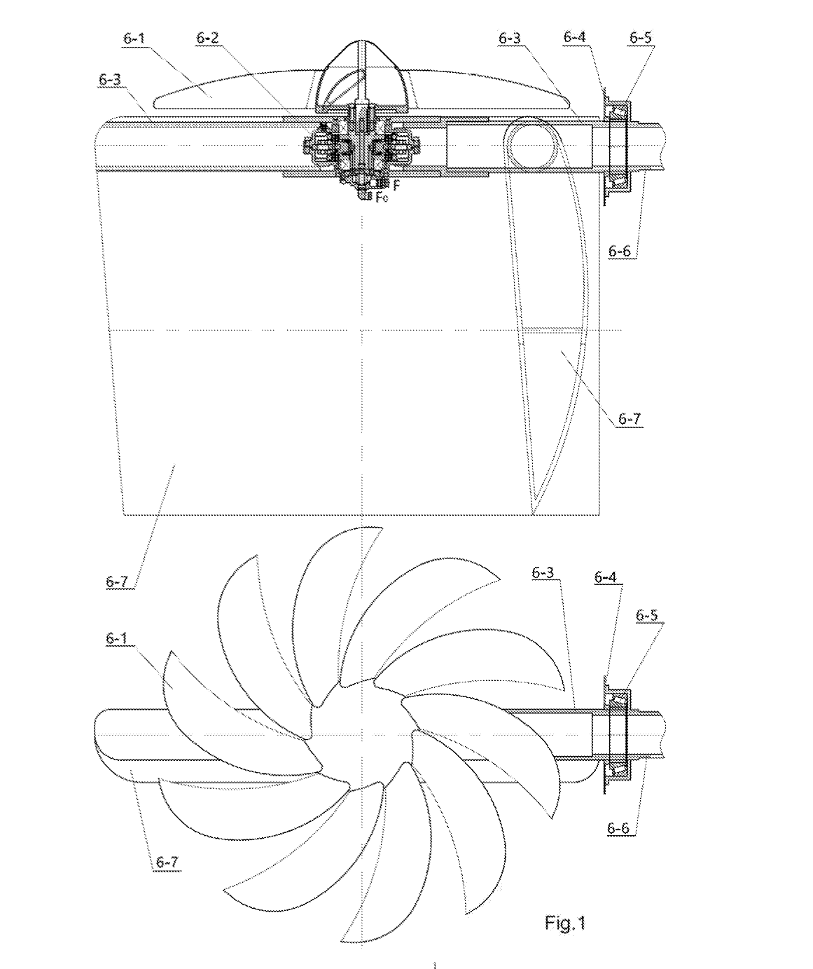

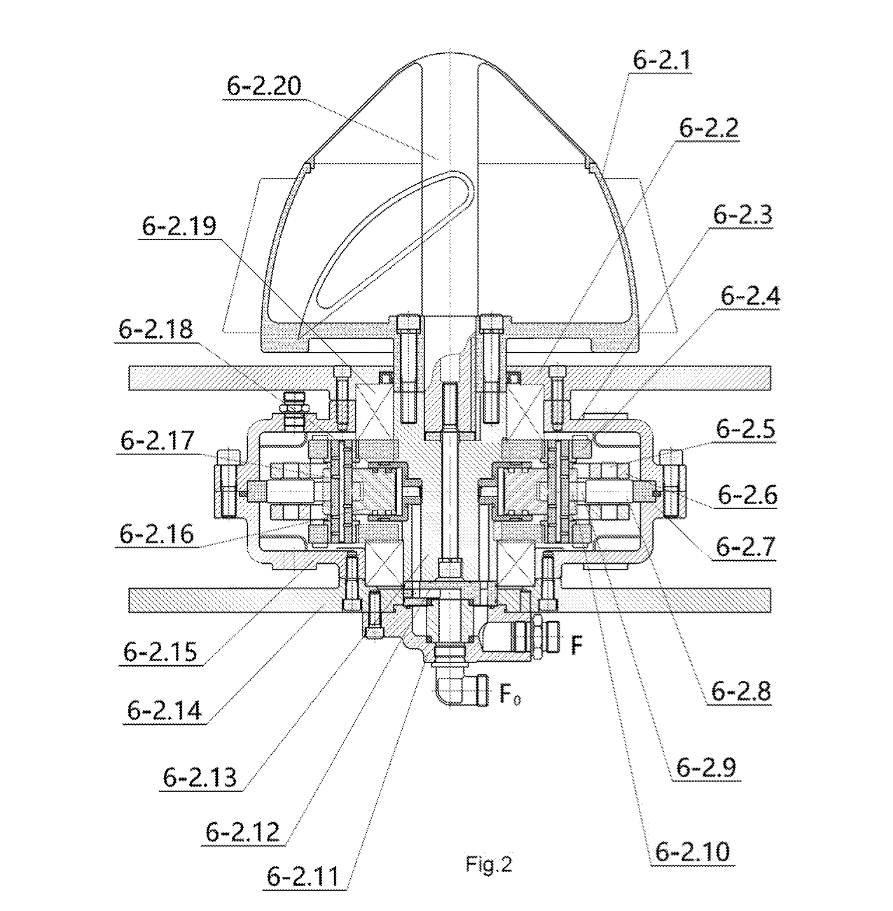

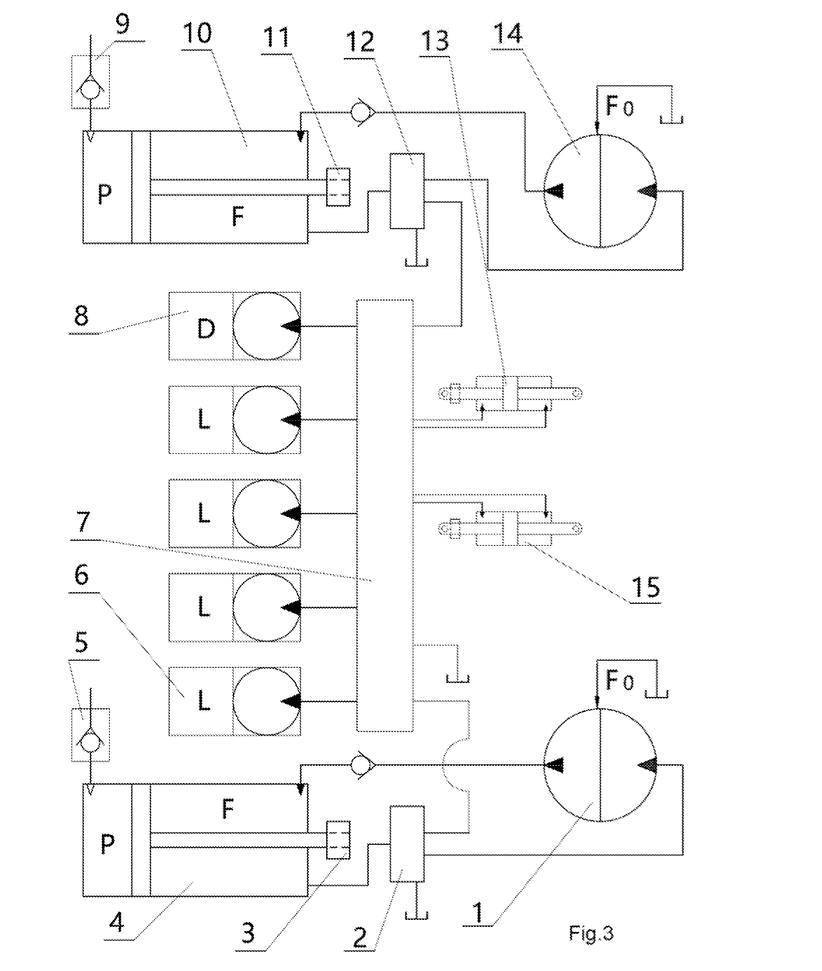

### CROSS-REFERENCE TO RELATED APPLICATIONS

This application is a continuation in part of International Patent Application No. PCT/CN2013/080164 with an international filing date of Jul. 26, 2013 designating the United States, now pending. The content of the aforementioned application, including any intervening amendments thereto, is incorporated herein by reference.

### TECHNICAL FIELD

The present invention relates to a gyroplane, which uses a radial hydraulic motor as driving power of two pairs of front and back fan propellers of the gyroplane for intending to improve the need of life environment while satisfying the power need of corresponding types.

### BACKGROUND OF THE PRESENT INVENTION

People feel boredom but have no alternative due to people's travel trouble such as existing traffic jam, etc. The research and development intend to provide people with a safe and effective air vehicle which has not high travel cost while not polluting the environment.

### SUMMARY OF THE PRESENT INVENTION

The present invention mainly adopts the technical solution that:

The gyroplane of the present invention uses the radial hydraulic motor for driving hydraulic pumps for pumping pressure oil to form hydraulic energy, also configures the radial hydraulic motor as the hydraulic energy for driving the executing elements of loads of the two pairs of front and back fan propellers, and is a gyroplane comprising rotating wing with hydraulically-operated fan propellers. The rotating wing with hydraulically-operated fan propellers comprises a radial hydraulic motor (6-2) and hydraulically-operated fan propellers (6-1). A wing rotating intermediate spar supported on a bearing (6-5) in a bearing support fixedly connected to a rotating wing fuselage (6-4) is fixedly connected with a wing rotating cantilever spar (6-3). A left wing rotating cantilever spar on the left side of the rotating wing fuselage and a right wing rotating cantilever spar on the right side of the rotating wing fuselage are fixedly connected to the wing rotating intermediate spar and distributed in bilateral symmetry. The wing rotating cantilever spar (6-3) is fixedly connected with the front end and the back end of a motor front connecting plate (6-2.2) and a motor back connecting plate (6-2.14) of a hydraulically-operated fan propeller motor (6-2), and frameworks on the rotating wings (6-7) are fixedly connected with the wing rotating cantilever spar. The present invention provides a safe and effective air vehicle with low cost.

### BRIEF DESCRIPTION OF THE DRAWINGS

FIG. (1) is a schematic diagram of one specific embodiment of a rotating wing with hydraulically-operated fan propellers (6) of the gyroplane, wherein:

| | |
|---|---|
| 6-1 hydraulically-operated fan | 6-2 radial hydraulic motor |
| propeller | |
| 6-3 wing rotating cantilever spar | 6-4 rotating wing fuselage |
| 6-5 bearing | 6-6 wing rotating intermediate spar |
| 6-7 rotating wing | |

FIG. (2) is a schematic diagram of one specific embodiment of a radial hydraulic motor (6-2) in the rotating wing with hydraulically-operated fan propellers (6), wherein:

| | |
|---|---|
| 6-2.1 fan propeller hub | 6-2.2 motor front connecting plate |
| 6-2.3 motor front end cover | 6-2.4 rotor positioning and guiding |
| | plate |
| 6-2.5 roller mandrel | 6-2.6 outer hinge bar |
| 6-2.7 motor curved guide rail | 6-2.8 roller |
| 6-2.9 middle hinge bar | 6-2.10 inner hinge bar |
| 6-2.11 motor connector end cover | 6-2.12 motor port plate |
| 6-2.13 motor rotor axis | 6-2.14 motor back connecting plate |
| 6-2.15 motor back end cover | 6-2.16 plunger |
| 6-2.17 plunger mandrel and guide | 6-2.18 cylinder liner |
| bushing | |
| 6-2.19 bearing | 6-2.20 seeker axis |

FIG. (3) is a schematic diagram of one specific embodiment of the gyroplane of the present invention, wherein:

| | |
|---|---|
| 1.1. hydraulically-operated hydraulic | 2. oil path control block |
| pump | |
| 3. linear displacement sensor | 4. gas & liquid energy-storage |
| | cylinder |
| 5. one-way control combination valve | 6. rotating wing with hydraulically- |
| | operated fan propellers |
| 7. hydraulic integrated control block | 8. hydraulically-operated generator |
| 9. one-way control combination valve | 10. gas & liquid energy-storage |
| | cylinder |
| 11. linear displacement sensor | 12. oil path control block |
| 13. front rotating wing oil cylinder | 14. hydraulically-operated |
| | hydraulic pump |
| 15. back rotating wing oil cylinder | |

### DETAILED DESCRIPTION OF THE PRESENT INVENTION

With reference to FIG. (1), the rotating wing with hydraulically-operated fan propellers comprises a radial hydraulic motor, fan propellers, etc., and is characterized in that: the radial hydraulic motor (6-2) of rotating wings (6-7) drives hydraulically-operated fan propellers (6-1) to operate; a wing rotating intermediate spar (6-6) supported on a bearing (6-5) in a bearing support fixedly connected to a rotating wing fuselage (64) is fixedly connected with a wing rotating cantilever spar (6-3) so that the rotating wings (6-7) can rotate around the midpoint of the wing rotating intermediate spar (6-6); a left wing rotating cantilever spar on the left side of the rotating wing fuselage and a right wing rotating cantilever spar on the right side of the rotating wing fuselage are supported on the wing rotating intermediate spar (6-6) and distributed in bilateral symmetry; the wing rotating cantilever spar (6-3) is fixedly connected with the front end and the back end of a motor front connecting plate (6-2.2) and a motor back connecting plate (6-2.14) of a hydraulically-operated fan propeller motor (6-2); and frameworks of the rotating wings (6-7) are fixedly connected with the wing rotating cantilever spar (6-3).

With reference to FIG. (2), the radial hydraulic motor of the rotating wing with hydraulically-operated fan propellers comprises: pressure oil F enters a confined space formed by the bottom of the cylinder liner (6-2.18) eccentrically and fixedly connected to the set circumference of the motor rotor axis (6-2.13) and the bottom of the plunger (6-2.16) via the motor connector end cover (6-2.11) along an oil path of the port plate (6-2.12) and an oil path of the motor rotor axis (6-2.13) of which the left end is supported by the bearing (6-2.19) fixedly connected in the motor front end cover (6-2.3) of the motor front connecting plate (6-2.2) and of which the right end is supported by the bearing (6-2.19) fixedly connected in the motor back end cover (6-2.15) of the motor back connecting plate (6-2.14); because the cylinder liner (6-2.18) is eccentrically and fixedly connected to the motor rotor axis (6-2.13) and an eccentric distance exists, oil pressure formed by the pressure oil F which acts on the bottom of the cylinder liner (6-2.18) points to the bottom of the cylinder liner (6-2.18) from the bottom of the plunger (6-2.16) for driving the motor rotor axis (6-2.13) to rotate and operate; due to the isotropy of the oil pressure, the oil pressure which acts on the bottom of the plunger (6-2.16) pushes the plunger (6-2.16) to operate along the inside of a line groove fixedly connected to a motor rotor positioning and guiding plate (6-2.4) of the motor rotor axis (6-2.13) under the guidance of a plunger mandrel and guide bushing (6-2.17) positioned on the head of the plunger (6-2.16); the oil pressure pushes the plunger (6-2.16) to be transferred to an outer hinge bar (6-2.6) via an inner hinge bar (6-2.10) hinged on the plunger mandrel of the plunger mandrel and guide bushing (6-2.17) and a middle hinge bar (6-2.9) engaged with the inner and the outer arcs of the inner hinge bar (6-2.10) in a manner of arc engagement; the middle hinge bar (6-2.9) is hinged in the middle of the outer hinge bar (6-2.6); one end of the outer hinge bar (6-2.6) is hinged on the positioning mandrel of the rotor positioning and guiding plate (6-2.4), and the other end is hinged with both ends of a roller mandrel (6-2.5) in a roller (6-2.8) which is operated along the inner curve of a motor curved guide rail (6-2.7) inlaid in the middle of the motor front end cover (6-2.3) and the motor back end cover (6-2.15); because the hinge bars accept the transfer force by an engagement point and the force transferring direction is the direction of transferring the oil pressure configured according to the system need, namely that the direction from pushing the plunger (6-2.16) in the cylinder liner (6-2.18) by the oil pressure to pushing the roller (6-2.8) by the outer hinge bar (6-2.6) and the tangential component force direction of the force of the motor curved guide rail (6-2.7) on the roller (6-2.8) are consistent with the rotating and operating direction of the motor rotor axis (6-2.13), the action that the oil pressure which acts on the bottom of the plunger (6-2.16) pushes the roller (6-2.8) and the action that the oil pressure on the bottom of the cylinder liner (6-2.18) drives the motor rotor axis (6-2.13) operate in the same direction and simultaneously apply work; the number of interactions of the travel section and the return section of the motor curved guide rail (6-2.7) is configured according to the system need; when the plunger (6-2.16) returns, F0 returns along the motor rotor axis (6-2.13), the port plate (6-2.12) and the oil path of the motor connector end cover (6-2.11) after cooled; for safe and reliable operation, the fan propeller hub (6-2.1) and the motor rotor axis (6-2.13) are fixedly connected; a seeker axis (6-2.20) which is in keyed joint with the fan propeller hub (6-2.1) and the motor rotor axis (6-2.13) simultaneously is also configured and fixedly connected to the motor rotor axis (6-2.13); and a lap joint section safe enough is arranged for the fixed connection of the fan propellers (6-1) and the fan propeller hub (6-2.1).

With reference to FIG. (3), the gyroplane comprises hydraulically-operated hydraulic pumps, the rotating wing with hydraulically-operated fan propellers, etc., and is characterized in that: the gyroplane uses the radial hydraulic motor for driving the hydraulic pumps for pumping pressure oil to form hydraulic energy, also configures the radial hydraulic motor (6-2) as the hydraulic energy for driving the executing elements of loads of the hydraulically-operated fan propellers (6-1), etc. on the left and the right rotating wings (6) with hydraulically-operated fan propellers. To ensure the safe reliability of the operation of the gyroplane, the gyroplane configures two hydraulic energy driving systems of which the hydraulically-operated hydraulic pump (1) and the hydraulically-operated hydraulic pump (14) pump pressure oil; one or two of the hydraulic energy driving systems can be operated as needed by the operation of the system configuration. A gas pressure cavity P of an oil & gas energy-storage cylinder (4) is filled with configured external pressure gas through a one-way combination valve (5), so that an oil pressure cavity of the oil & gas energy-storage cylinder (4) has oil pressure F; the oil pressure F drives the radial hydraulic motor of the hydraulically-operated hydraulic pump (1) to have enough driving power; the oil pressure F controls the hydraulically-operated hydraulic pump (1) through an oil path control block (2) to pump the pressure oil to be injected into the oil pressure cavity of the oil & gas energy-storage cylinder (4) for compressing the upper gas pressure cavity space; and a displacement sensor (3) detects in real time to instruct the oil path control block (2) to perform real-time adjustment and control so that the oil pressure F and the gas pressure P are increased to system set values and kept in the scope of the system configuration need. Similarly, the gas pressure cavity P of the oil & gas energy-storage cylinder (10) is filled with configured external pressure gas through a one-way combination valve (9), so that an oil pressure cavity of the oil & gas energy-storage cylinder (10) has oil pressure F; the oil pressure F drives the radial hydraulic motor of the hydraulically-operated hydraulic pump (14) to have enough driving power; the oil pressure F controls the hydraulically-operated hydraulic pump (14) through an oil path control block (12) to pump the pressure oil to be injected into the oil pressure cavity of the oil & gas energy-storage cylinder (10) for compressing the upper gas pressure cavity space; a displacement sensor (11) detects in real time to instruct the oil path control block (12) to perform real-time adjustment and control so that the oil pressure F and the gas pressure P are increased to system set values and kept in the scope of the system configuration need; the oil pressure F is adjusted and controlled by a hydraulic integrated control block (7) for driving a hydraulic generator set (8) according to the system configuration to operate and generate electricity to satisfy the electricity need of the gyroplane; and the oil pressure F is adjusted and controlled by the hydraulic integrated control block (7) for driving the hydraulically-operated fan propellers (6-1) mounted on two pairs of front and back rotating wings (6) with hydraulically-operated fan propellers to operate according to the system configuration to satisfy the power drive need of the gyroplane. The hydraulic integrated control block (7) performs adjustment and control for respectively driving a front rotating wing oil cylinder (13) and a back rotating wing oil cylinder (15) of which one end is hinged on the rotating wing fuselage (6-4) and the other end is hinged on the rotating arm of the wing rotating intermediate spar (6-6) to operate according to the system configuration so that the hydraulic integrated control block (7) pushes the front and the back rotating wings (6-7) to operate around the midpoint of the wing rotating intermediate spar (6-6) according to a rotating angle configured by the system. The application of combination and integration of system configurations can realize multiple transformations to adapt to the system configuration needs of gyroplanes with hydraulically-operated fan propellers for various purposes.

I claim:

1. A rotating wing with hydraulically-operated fan propellers, characterized in that: a radial hydraulic motor (6-2) of rotating wings (6-7) drives hydraulically-operated fan propellers (6-1) to operate; and a wing rotating intermediate spar (6-6) supported on a bearing (6-5) in a bearing support fixedly connected to a rotating wing fuselage transverse spar (6-4) is fixedly connected with a wing rotating cantilever spar (6-3) so that the rotating wings (6-7) can rotate around the midpoint of the wing rotating intermediate spar (6-6).

2. The rotating wing with hydraulically-operated fan propellers of claim 1, characterized in that: a left wing rotating cantilever spar on the left side of the rotating wing fuselage and a right wing rotating cantilever spar on the right side of the rotating wing fuselage are supported on the wing rotating intermediate spar (6-6) and distributed in bilateral symmetry; the wing rotating cantilever spar (6-3) is fixedly connected with the front end and the back end of a motor front connecting plate (6-2.2) and a motor back connecting plate (6-2.14) of the radial hydraulic motor (6-2); frameworks of the rotating wings (6-7) are fixedly connected with the wing rotating cantilever spar (6-3).

3. The rotating wing with hydraulically-operated fan propellers of claim 1, characterized in that: a fan propeller hub (6-2.1) is fixedly connected with a motor rotor axis (6-2.13); a seeker axis (6-2.20) which is in keyed joint with the fan propeller hub (6-2.1) and the motor rotor axis (6-2.13) simultaneously is also configured and fixedly connected to the motor rotor axis (6-2.13).

4. The rotating wing with hydraulically-operated fan propellers of claim 1, characterized in that: a lap joint section safe enough is arranged for the fixed connection of the fan propellers (6-1) and the fan propeller hub (6-2.1).

5. A gyroplane, characterized by being a gyroplane comprising the rotating wing with hydraulically-operated fan propellers of claim 1; the gyroplane configures the radial hydraulic motor (6-2) as hydraulic energy for driving the executing elements of loads of the hydraulically-operated fan propellers (6-1), etc. on left and right rotating wings with hydraulically-operated fan propellers (6); the gyroplane configures two hydraulic energy driving systems of which the hydraulically-operated hydraulic pump (1) and the hydraulically-operated hydraulic pump (14) pump pressure oil; one or two of the hydraulic energy driving systems can be operated as needed by system configuration.

6. The gyroplane of claim 5, characterized in that: a gas pressure cavity P of an oil & gas energy-storage cylinder (4) is filled with configured external pressure gas through a one-way combination valve (5), so that an oil pressure cavity of the oil & gas energy-storage cylinder (4) has oil pressure F; the oil pressure F drives the radial hydraulic motor of the hydraulically-operated hydraulic pump (1) to have enough driving power; the oil pressure F controls the hydraulically-operated hydraulic pump (1) through an oil path control block (2) to pump the pressure oil to be injected into the oil pressure cavity of the oil & gas energy-storage cylinder (4) for compressing the upper gas pressure cavity space; and a displacement sensor (3) detects in real time to instruct the oil path control block (2) to perform real-time adjustment and control so that the oil pressure F and the gas pressure P are increased to system set values and kept in the scope of the system configuration need.

7. The gyroplane of claim 5, characterized in that: the oil pressure F is adjusted and controlled by a hydraulic integrated control block (7) for driving a hydraulic generator set (8) according to the system configuration to operate and generate electricity to satisfy the electricity need of the gyroplane; and the oil pressure F is adjusted and controlled by the hydraulic integrated control block (7) for driving the hydraulically-operated fan propellers (6-1) mounted on two pairs of front and back rotating wings with hydraulically-operated fan propellers (6) to operate according to the system configuration to satisfy the power drive need of the gyroplane.

8. The gyroplane of claim 5, characterized in that: the hydraulic integrated control block (7) performs adjustment and control for respectively driving a front rotating wing oil cylinder (13) and a back rotating wing oil cylinder (15) of which one end is hinged on the rotating wing fuselage (6-4) and the other end is hinged on the rotating arm of the wing rotating intermediate spar (6-6) to operate according to the system configuration so that the hydraulic integrated control block (7) pushes the front and the back rotating wings (6-7) to operate around the midpoint of the wing rotating intermediate spar (6-6) according to a rotating angle configured by the system.
